(19) United States
(12) Patent Application Publication
(10) Pub. No.: US 2023/0245077 A1
(43) Pub. Date: Aug. 3, 2023

(54) VIDEO CONFERENCING SYSTEM AND METHOD FOR ROOM NEATNESS DETECTION AND MESSAGING THEREOF

(71) Applicant: Plantronics, Inc., Santa Cruz, CA (US)

(72) Inventors: Rajen BHATT, McDonald, PA (US); Donald L. ECKHART, Little Elm, TX (US); Raghavendra BALAVALIKAR KRISHNAMURTHY, Austin, TX (US); David A. BRYAN, Cedar Park, TX (US); Keith C. KING, Austin, TX (US)

(21) Appl. No.: 17/649,402

(22) Filed: Jan. 31, 2022

(51) Int. Cl. G06Q 10/00; G06Q 10/10; G06N 3/08; G06T 7/70

(52) U.S. Cl. CPC G06Q 10/30; G06Q 10/1093; G06N 3/08; G06T 7/70

(57) ABSTRACT

Providing a facilities supervisor notice after a conference room or other common area has been used and is in a messy condition. An image of the conference room obtained after use is evaluated to determine if the conference room is neat. A neatness score is obtained for the conference room. If the score indicates a neatness value above a settable level, the conference room is considered clean and ready for use. If the neatness score indicates a neatness value less than the settable level, the conference room is not ready for use, and a notice is provided to the facilities supervisor to allow a cleaning person to be dispatched. The need to perform the cleanliness or neatness review is triggered by referencing scheduled meetings in a calendaring system, by monitoring the conference room for the presence of individuals having an unscheduled meeting and periodically or randomly.

### TECHNICAL FIELD

This disclosure relates generally to automatic determination and notification of room status.

### BACKGROUND

In a larger office building or complex, a facilities supervisor has the responsibility that all of the facilities in the building or complex are properly operating or configured for use. One example of interest here is the state of common areas, particularly conference rooms, after the common area has been used. Users of a conference room often fail to clean the conference room before they leave. There is writing on a whiteboard. There are papers and food containers strewn over the conference table. The wastebasket is overflowing. The chairs are in disarray. This means that at least the conference is very messy or dirty for the next users. It may also mean that confidential materials are available in the room, such as the writing on the whiteboard and papers that are still present, which is a breach of most security protocols.

While facilities cleaning staff can be assigned to perform these duties, this becomes an appreciable expense as the building or complex likely has many conference rooms and other common areas to monitor, with frequent turnover of the rooms, effectively requiring dedicated personnel.

### BRIEF DESCRIPTION OF THE DRAWINGS

For illustration, there are shown in the drawings certain examples described in the present disclosure. In the drawings, like numerals indicate like elements throughout.

The full scope of the inventions disclosed herein are not limited to the precise arrangements, dimensions, and instruments shown. In the drawings:

FIG. 1 is an illustration of a conference room containing a table, a whiteboard, a wastebasket, a monitor, a videoconferencing endpoint and chairs.

FIG. 2 is an image of the conference room of FIG. 1 in neat condition.

FIG. 3 is an image of the conference room of FIG. 1 in a messy condition.

FIG. 4 is a block diagram of a network according to an example of the present disclosure.

FIG. 5 is a flowchart of operation of a calendaring server according to an example of the present disclosure.

FIG. 6 is a flowchart of operation of a videoconferencing endpoint according to an example of the present disclosure.

FIG. 7 is a flowchart of operation of a facilities server according to an example of the present disclosure.

FIG. 7A is a flowchart of clean room processing using traditional computer vision processing according to an example of the present disclosure.

7B is a flowchart of clean room processing using neural network processing according to an example of the present disclosure.

FIG. 8 is a block diagram of a videoconferencing endpoint according to an example of the present disclosure.

FIG. 9 is a block diagram of the processor unit of FIG. 8.

FIG. 10 is a block diagram of a calendaring server according to an example of the present disclosure.

FIG. 11 is a block diagram of a facilities server according to an example of the present disclosure.

FIG. 12 is a block diagram of a facilities supervisor computer according to an example of the present disclosure.

### DETAILED DESCRIPTION

Examples according to this description provide a facilities supervisor a notice after a conference room or other common area has been used and is in a messy or dirty condition. An image is obtained of the conference room after use and is evaluated to determine if the conference room is in a clean or neat condition. Using one of several techniques, a cleanliness or neatness score is obtained for the conference room after use. If the score indicates a neatness value above that specified by the settable level, the conference room is considered clean and ready for use. If the neatness score indicates a neatness value less than that of the settable level, the conference room is not ready for use, and a notice is provided to the facilities supervisor to allow a cleaning person to be dispatched.

The need to perform the cleanliness or neatness review is triggered several ways. A first way is by referencing scheduled meetings in a calendaring system and triggering after a scheduled meeting is completed. A second way is by monitoring the conference room for the presence of individuals having an unscheduled meeting. The individuals leaving the conference room triggers a cleanliness review. A third way is a periodic or random check, after confirming the conference room is not in use.

One technique for determining the conference room cleanliness level performs object or feature detection on both a reference image, made when the conference room is configured as desired, and the post-meeting image. The detected objects and features of the two images are compared and analyzed using a distance algorithm or a structural similarity index, with a resulting score to be used for comparison to the settable neatness score.

Another technique uses a neural network trained with both clean and dirty images. The post-meeting image is provided to the neural network and a confidence score is proved as an output; the confidence score compared to the settable neatness score.

By performing the post-meeting image analysis to determine room cleanliness or neatness, cleaning staff is dispatched only when necessary and is not required to continually monitor the many conference rooms and other common areas in the office building or complex. This saves expense by reducing the need for cleaning staff to continually check the state of the conference rooms.

In the drawings and the description of the drawings herein, certain terminology is used for convenience only and is not to be taken as limiting the examples of the present disclosure. In the drawings and the description below, like numerals indicate like elements throughout.

Computer vision is an interdisciplinary scientific field that deals with how computers can be made to gain high-level understanding from digital images or videos. Computer vision seeks to automate tasks imitative of the human visual system. Computer vision tasks include methods for acquiring, processing, analyzing, and understanding digital images, and extraction of high-dimensional data from the real world to produce numerical or symbolic information. Computer vision is concerned with artificial systems that extract information from images. Computer vision includes algorithms which receive a video frame as input and produce data detailing the visual characteristics that a system has been trained to detect.

Traditional computer vision techniques perform feature extraction and object detection in various ways. In one example, edge detection is used to identify relevant points in an image. These relevant points can be compared to models to identify the particular object and its orientation. If this object detection is performed on a reference image, particularly if the reference image has the relevant objects marked, object detection than can be performed on a sample image. The objects found in the sample image can then be compared to the objects in the reference image. Various techniques can be used to determine how close of a match the sample image is to the reference image, many involving various distance algorithms or a structural similarity index (SSIM).

A convolutional neural network is a class of deep neural network which can be applied to analyzing visual imagery. A deep neural network is an artificial neural network with multiple layers between the input and output layers.

Artificial neural networks are computing systems inspired by the biological neural networks that constitute animal brains. Artificial neural networks exist as code being executed on one or more processors. An artificial neural network is based on a collection of connected units or nodes called artificial neurons, which mimic the neurons in a biological brain. Each connection, like the synapses in a biological brain, can transmit a ‘signal’ to other neurons. An artificial neuron that receives a signal then processes it and can signal neurons connected to it. The signal at a connection is a real number, and the output of each neuron is computed by some non-linear function of the sum of its inputs. The connections are called edges. Neurons and edges have weights, the value of which is adjusted as ‘learning’ proceeds or as new data is received by a state system. The weight increases or decreases the strength of the signal at a connection. Neurons may have a threshold such that a signal is sent only if the aggregate signal crosses that threshold.

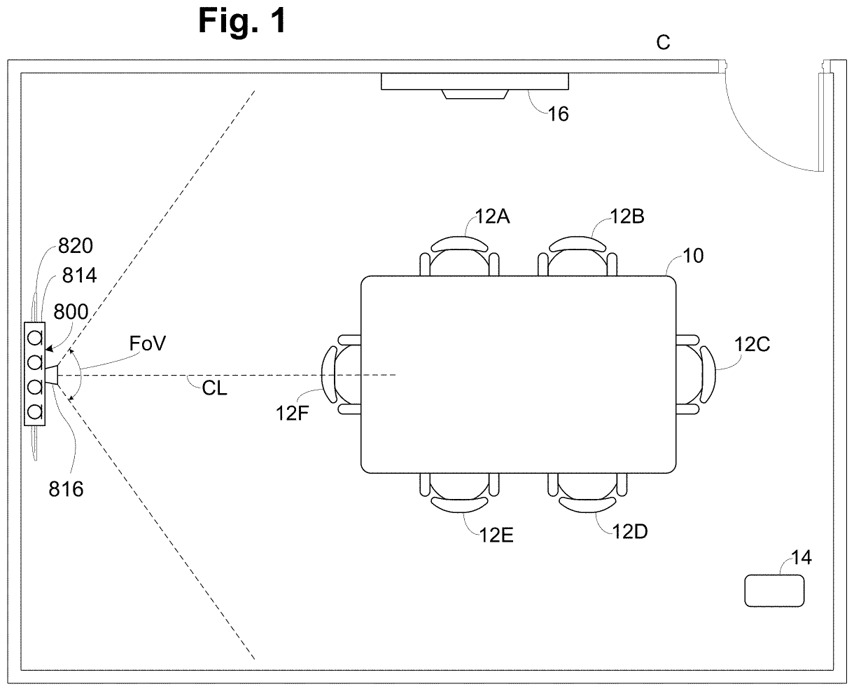

Referring now to FIG. 1, a conference room C configured for use in videoconferencing is illustrated. Conference room C includes a conference table 10 and a series of chairs 12A-12F. A wastebasket 14 is included in one corner of the conference room C. A whiteboard 16 is located on one wall of the conference room C. A videoconferencing endpoint 800, which includes an imager 816 to view individuals seated in the various chairs 12 and a microphone array 814 to determine speaker direction, is provided at one end of the conference room C. A monitor or television 820 is provided to display the far end conference site or sites and generally to provide the loudspeaker output.

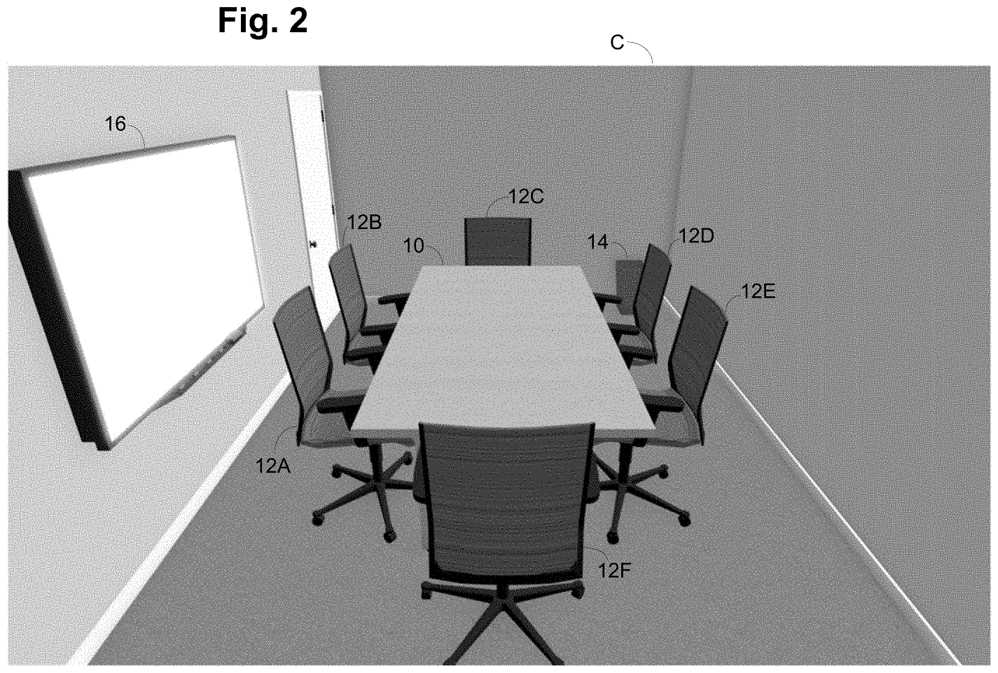

In FIG. 2, a clean or neat conference room C is illustrated. The chairs 12A-12F are neatly arranged around the table 10. There are no objects on the table 10. There is no writing on the whiteboard 16. The wastebasket 14 is empty. This is the look of a conference room ready to be occupied by individuals to have a meeting or conference.

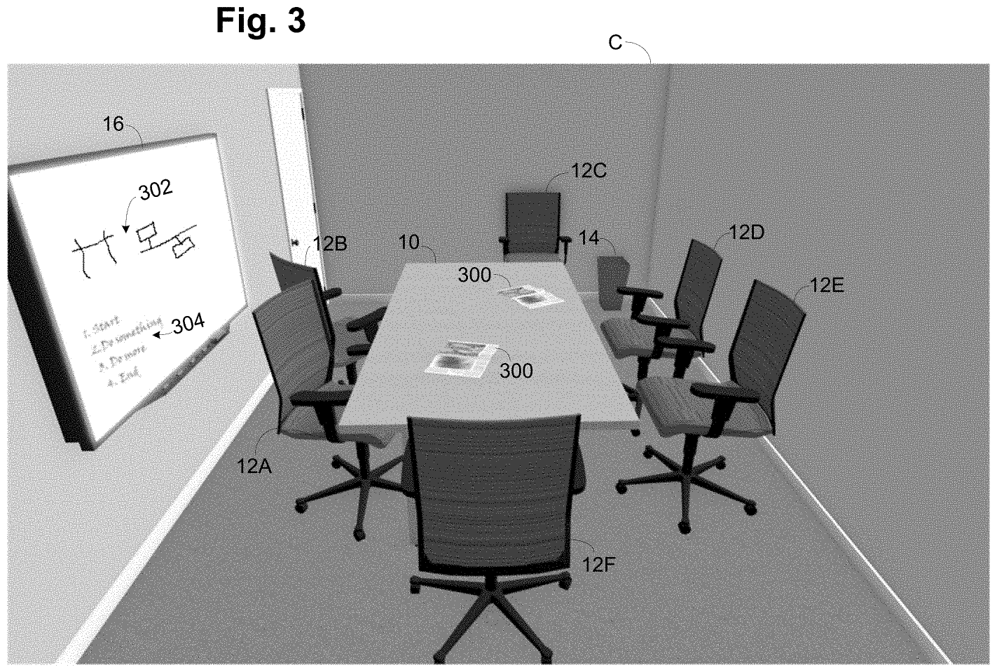

FIG. 3, by contrast, illustrates a messy or dirty conference room C. Chair 12A is rotated clockwise. Chair 12B is pulled back from the table 10 and rotated counterclockwise. Chair 12C is pulled away from the table 10, moved to the right and is near the wall. Chairs 12D and 12E have been pulled back from the table 10. Items 300, such as magazines, notes, handouts, etc. are present on the table 10. Drawings 302 and notes 304 are present on the whiteboard 16. This is the look of a conference room not ready to have a meeting or conference.

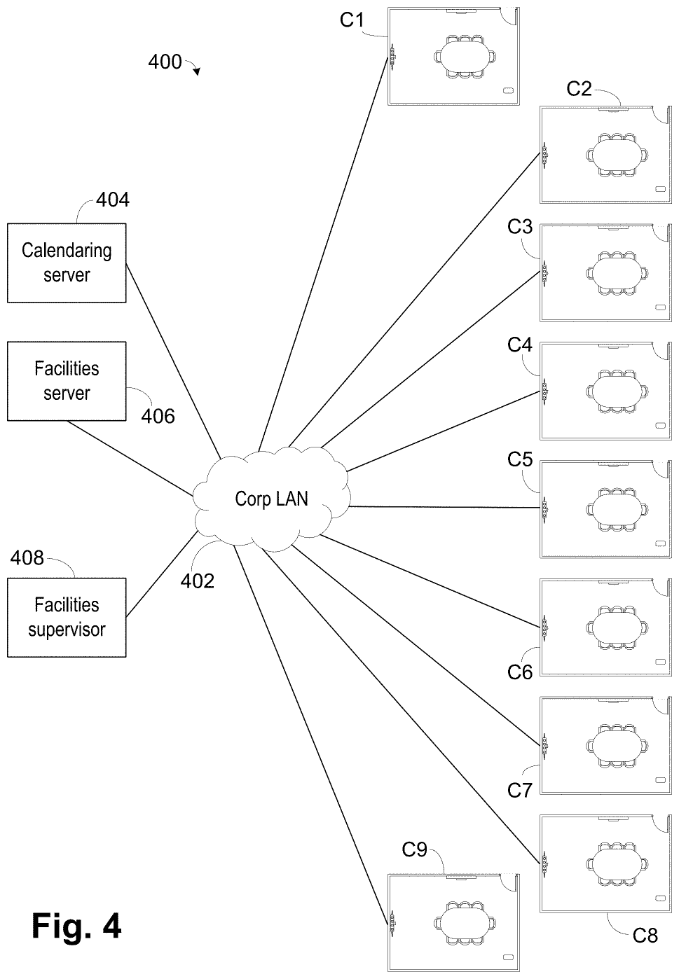

FIG. 4 illustrates an office environment 400. There are a series of conference rooms C1-C9. A corporate LAN 402 is the communication interconnect. The videoconferencing endpoint 800 in each conference room C1-C9 is connected to the corporate LAN 402. A calendaring server 404 is connected to the corporate LAN 402. The calendaring server 404 executes meeting or calendaring software used to schedule the use of the conference rooms C1-C9. Exemplary meeting or calendaring software includes Microsoft® Exchange™ and Poly™ Clariti™. Both handle scheduling of facilities, such as conference rooms, and interact with user programs such as Microsoft Outlook®. A facilities server 406 is connected to the corporate LAN 42. The operation of the facilities server 406 is discussed below. A facilities supervisor computer 408 is connected to the corporate LAN 42. The relevant operation of the facilities supervisor computer 408 is discussed below.

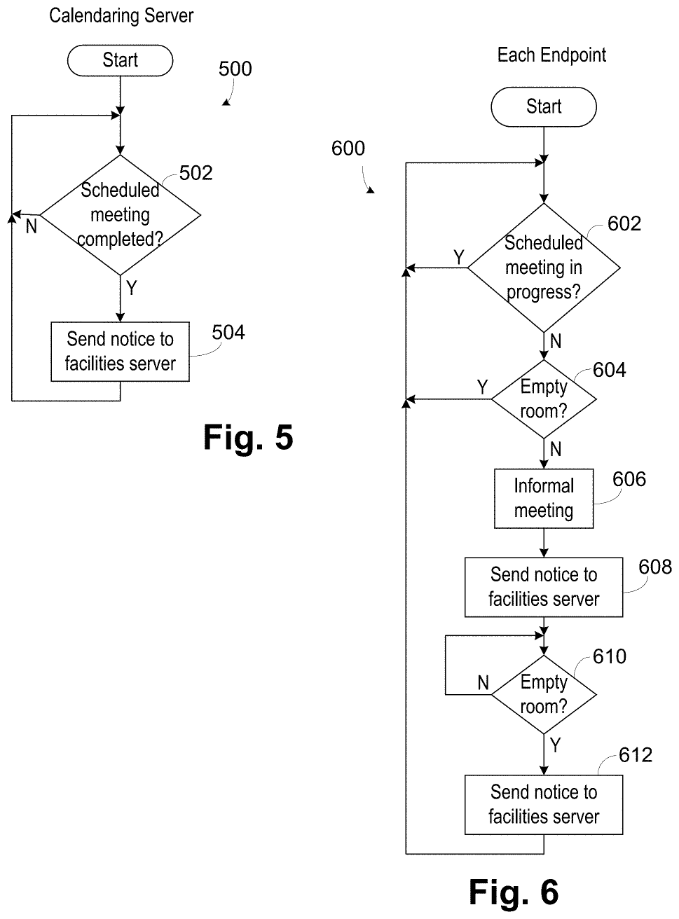

FIG. 5 illustrates the operation 500 of the calendaring server 404 providing notice of the completion of a scheduled meeting. In step 502, the calendaring server 404 determines if a scheduled meeting in a conference room has completed. In some examples this determination is made at the scheduled completion time and in some examples is made some period after the scheduled completion time to allow the individuals time to leave the conference room. If there is no scheduled meeting completion, operation returns to step 502. If there is a scheduled meeting completion, in step 504 a notice is sent to the facilities server 406 indicating the completion of the meeting. Operation returns to step 502.

FIG. 6 illustrates the operation 600 of each videoconferencing endpoint 800. In step 602, it is determined if a scheduled meeting is in progress by checking with the calendaring server 404. If so, operation returns to step 602. If no scheduled meeting is in progress, in step 604 it is determined if the conference room is empty. This is done in one example by sampling a frame from the imager 816 or an external camera 819 and performing face or body detection on the frame. If the conference room is empty, operation returns to step 602. If the conference room is not empty, this indicates an informal meeting is in progress and this state is set in step 606. It is noted that this condition of individuals using the conference room can be met by individuals remaining in the conference room after a scheduled meeting or from individuals entering a previously empty conference room. In step 608, a notice of the informal meeting is provided to the facilities server 406 for record keeping purposes. In step 610, it is again determined if the conference room is empty. If not, operation returns to step 610. If the conference room is empty, in some examples, and some period after the conference room is empty in some examples, a notice of the informal conference completion is provided to the facilities server 406 in step 612. Operation returns to step 602.

In some examples, only one of the calendaring server 404 operations of FIG. 5 and the videoconferencing endpoint 800 operations of FIG. 6 is used. Using only the calendaring server 404 operations of FIG. 5 allows the use of simpler videoconferencing endpoints at the risk of missing informal meetings. Using only the videoconferencing endpoint 800 operations of FIG. 6 removes the room checking after scheduled meetings that do not occur. Further, the calendar checking step 602 is not needed, removing the need to link the calendaring server 404 and the videoconferencing endpoints 800. The combination of both the calendaring server 404 operations of FIG. 5 and the videoconferencing endpoint 800 operations of FIG. 6 covers all meeting types, scheduled and informal, and reduces the workload on the videoconferencing endpoints 800 during scheduled meetings when the videoconferencing endpoints 800 are likely to be busy performing videoconferencing functions.

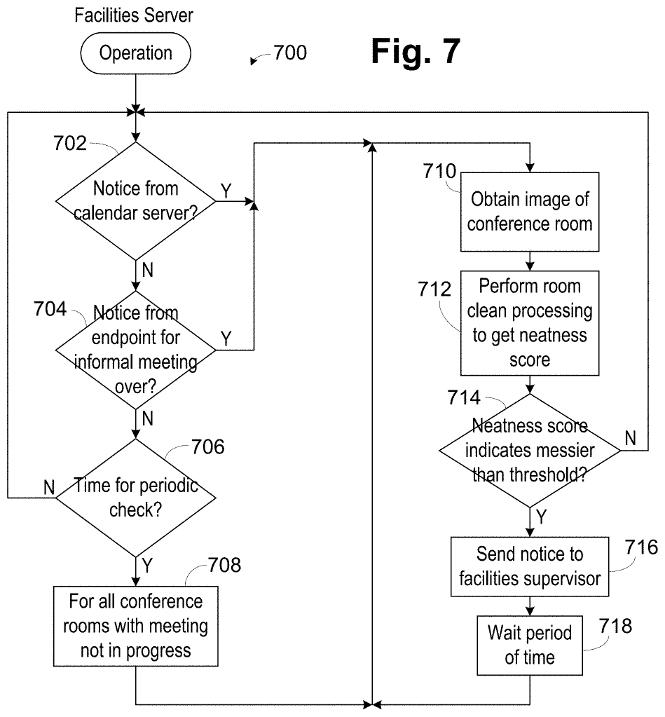

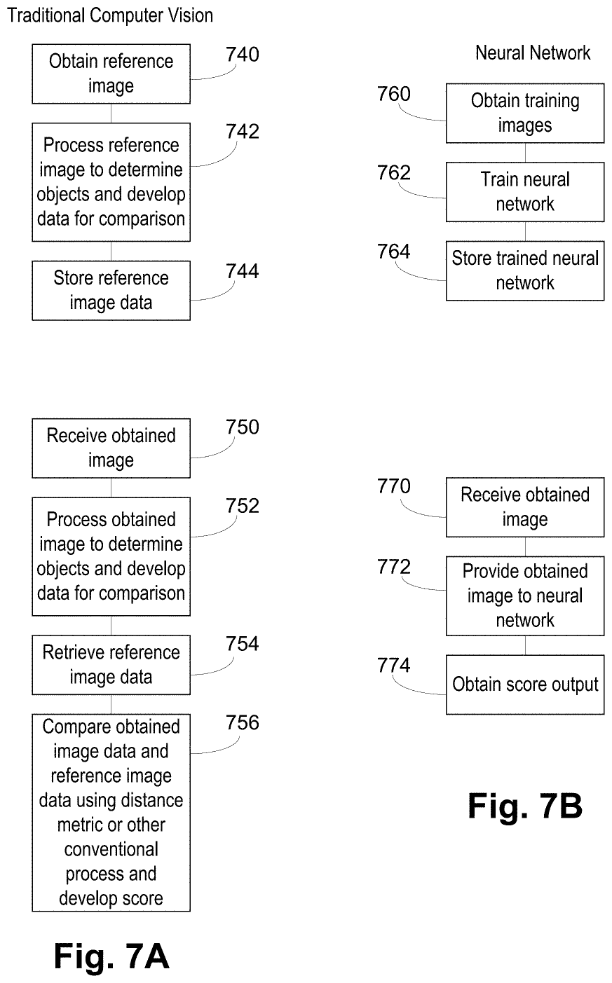

FIG. 7 illustrates the operation 700 of the facilities server 406. In step 702, the facilities server 406 determines if a meeting completion notice has been received from the calendaring server 404. If not, in step 704 the facilities server 406 determines if an informal meeting completion notice has been received from a videoconferencing endpoint 800. If not, in step 706 the facilities server 406 determines if it is time for a periodic or random check of the neatness or cleanliness of the conference rooms. If not, operation returns to step 702. If it is time for a check, then for all conference rooms not currently having a scheduled or informal meeting as can be determined by contacting the calendaring server 404 and based on the informal meeting notices from the videoconferencing endpoints 800, in step 710 an image of the conference room is obtained from the videoconferencing server. Step 710 is also performed after a completion notice from the calendaring server 404 in step 702 or from an endpoint in step 704.

In step 712, the obtained image is processed to develop a neatness score to determine if the conference room is sufficiently clean for use. This processing is detailed below and in FIGS. 7A and 7B. In step 714 it is determined if the neatness score indicates the conference room is messier than a selectable threshold value. In some examples the processing of step 712 provides a different output metric and that metric is compared in step 714 to determine if the conference room is messier than the selectable threshold value. The selectable threshold value can be the same for all conference rooms C or can be varied for each conference room C to account for differences in each conference room C. For example, the threshold may be set higher for simple conference room as illustrated in FIGS. 1-3 or can be set lower if the conference room is much larger and has many more objects to evaluate. A neatness score above the threshold indicates the conference room C is considered neat enough for use. A neatness score below the threshold indicates the conference room is considered too messy to use for a meeting. If neat or clean, operation returns to step 702. If messy or dirty, in step 716 a messy or dirty notice is provided to the facilities supervisor via the facilities supervisor computer 408 so that cleaning staff can be dispatched to the conference room. The facilities supervisor can also send a reminder to the organizer of the meeting that was held in the conference room that the conference room should be cleaned up before leaving it. In some examples, where the tasks of the cleaning staff are assigned by a staffing server, the notice can be provided to the staffing server instead of or in addition to the facilities supervisor. In some examples, this notice of messy or dirty is a simple text-based message. In some examples, a copy of the obtained image and the relevant reference image are provided with the text-based message to allow the facilities supervisor to make an independent review. In step 718, a delay of a determined period of time is performed. This delay can be a fixed amount or can be an amount dependent on the scheduling of the next meeting the conference room. This delay is provided to allow the cleaning staff time to clean or arrange the conference room. After the delay is completed, operation returns to step 710 to reexamine the conference room.

The room clean processing of step 712 is performed in different manners in different examples. In one group of examples, traditional computer vision processing is performed. In another group of examples, deep learning and neural networks are used.

Referring to FIG. 7A, in the traditional computer vision examples, a reference image is provided for each conference room in step 740. Preferably the reference image has the desired objects marked and is taken using the videoconferencing endpoint 800 as installed in the conference room to minimize scale concerns and other image clarity concerns. For example, referring to FIG. 2, the marked objects would include the clean table 10, the empty wastebasket 14, clean whiteboard 16 and the chairs 12A-12F neatly aligned and pushed up to the table 10. Relevant data is extracted from the reference image in step 742 and stored for comparison with capture images in step 744. Relevant data is based on the particular techniques being used, but can include feature points, edges, image hashes, object-based descriptions and the like.

When an image is obtained in step 710, that obtained image is received in step 750 for processing. The obtained image is processed in the same manner as the reference image in step 752, except that the objects are not marked. The computer vision processing develops relevant data similar to that stored for the reference image. The reference image data is retrieved in step 754. The features determined in the obtained image are compared to the features determined in the reference image in step 756, in some examples using one of various distance algorithms, such as Euclidian distance, Hamming distance, cosine distance and the like. In other examples, a structural similarity index (SSIM) is used to compare the features in the two images.

Referring to FIG. 3, the computer vision processing compares the table 10 including the items 300 to the clean table 10 and determines the dissimilarity caused by the items 300. The computer vision processing compares the whiteboard 16 with the drawings 302 and notes 304 with the clean whiteboard 16 and determines the dissimilarity caused by the drawings 302 and notes 304. The computer vision processing compares the moved chairs 12A-12E with the correctly located chairs 12A-12E and determines the dissimilarity caused by the chairs 12A-12E being rotated or moved. The computer vision processing compares the chairs 12F with the correctly located chair 12F and determines that the objects are the same, as the chair 12F has not been moved. The computer vision processing compares the empty wastebasket 14 of FIG. 3 with the empty wastebasket 14 of FIG. 2 and determines that the objects are the same.

The end result of the image comparison of step 756 is a score value, conceptually the higher the score, the higher the image similarity. This may require inversion of the distance result as a more similar image will generally have a lower distance result. Alternatively, if direct distance results are desired to be used, then a distance result less than the threshold would indicate a cleaner, neater conference room. This discussion will generally use a higher score indicating a cleaner room for ease of understanding. Inversion can be done if desired and the changes to the described threshold comparison would then also be done. The more general statement would be that a distance score indicating a cleaner conference room than specified by the threshold value would be passed and a distance score indicating a dirtier room than specified by the threshold value would result in the notice being provided to the facilities supervisor.

Referring to FIG. 7B, deep learning methods start by obtaining a number of sample or training images, preferably ranging from perfectly clean to very messy, in step 760. These sample images are classified as clean or dirty, in some instances with a score, and then used to train the neural network in step 762. The values of the trained neural network are stored in step 764. Once the neural network is trained, an obtained image received in step 770, is provided to the neural network om step 772 and a cleanliness score is provided as an output in step 774. This score is then compared to the threshold as discussed above.

Many factors determine the use of traditional computer vision methods or deep learning methods. The traditional computer vision method has the advantage that the collection of the images of the conference room in clean and messy conditions is not required, just the single clean reference image. Additionally, traditional computer vision methods generally require fewer computing resources, as neural networks are often very large and require intensive computations. However, in specific environments, the deep learning method may provide better results.

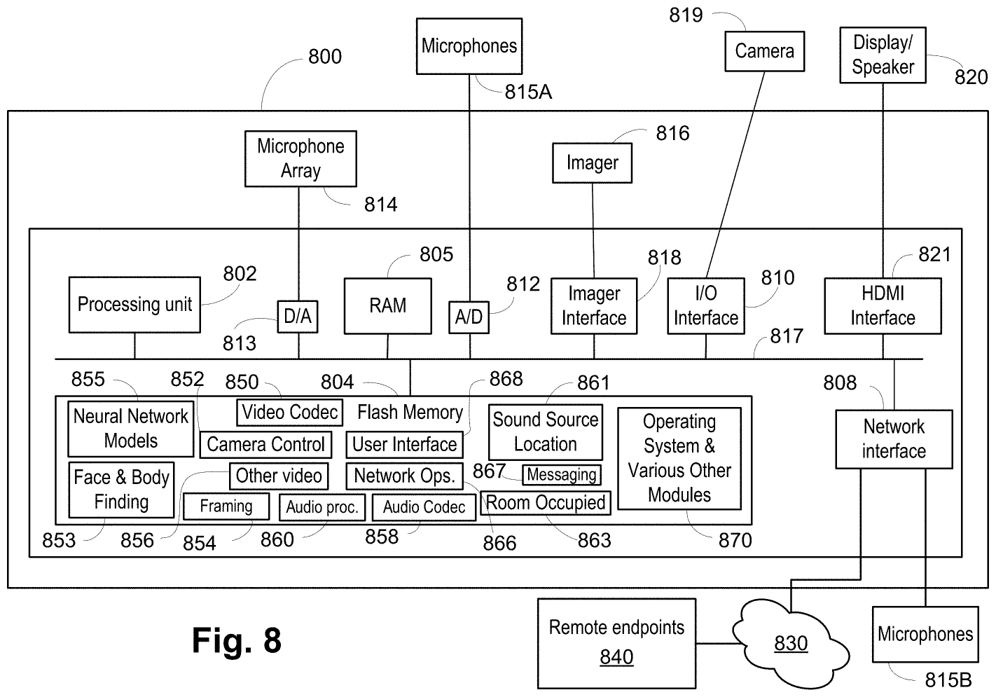

FIG. 8 illustrates aspects of a videoconferencing endpoint Boo in accordance with an example of this disclosure. The videoconferencing endpoint Boo may include loudspeaker(s) 822, though in many cases the loudspeaker 822 is provided in the monitor 820, and microphone(s) 815A interfaced via interfaces to a bus 817, the microphones 815A through an analog to digital (A/D) converter 812 and the loudspeaker 822 through a digital to analog (D/A) converter 813. A microphone array 814 is connected to a D/A converter 813, which is connected to the bus 817. The videoconferencing endpoint 800 also includes a processing unit 802, a network interface 808, a flash memory 804, RAM 805, and an input/output (I/O) general interface 810, all coupled by bus 817. An imager 816 is connected to an imager interface 818, which is connected to the bus 817. The imager 816 acts as an onboard camera. An external camera 819 can be connected to the I/O interface 810. External local microphone(s) 819A are connected to an A/D converter 812, which is connected to the bus 817. External network microphone(s) 819B are connected to the network interface 808. An HDMI interface 821 is connected to the bus 817 and to the external display or monitor 820. Bus 817 is illustrative and any interconnect between the elements can used, such as Peripheral Component Interconnect Express (PCIe) links and switches, Universal Serial Bus (USB) links and hubs, and combinations thereof.

The processing unit 802 can include digital signal processors (DSPs), central processing units (CPUs), graphics processing units (GPUs), dedicated hardware elements, such as neural network accelerators and hardware videoconferencing endpoints, and the like in any desired combination.

The flash memory 804 stores modules of varying functionality in the form of software and firmware, generically programs or instructions, for controlling the videoconferencing endpoint 800. Illustrated modules include a video codec 850, camera control 852, face and body finding 853, neural network models 855, framing 854, room occupied 863, messaging 867, other video processing 856, camera location and selection 857, audio codec 858, audio processing 860, sound source localization 861, network operations 866, user interface 868 and operating system and various other modules 870. The RAM 805 is used for storing any of the modules in the flash memory 804 when the module is executing, storing video images of video streams and audio samples of audio streams and can be used for scratchpad operation of the processing unit 802. The room occupied module 863 uses the neural network models 855 and face and body finding 853 to determine if the conference room C is occupied or has been empty as discussed with FIG. 6. The messaging module 867 provides notices to the facilities server 406 when the room occupied module 863 determines that an unscheduled meeting in the conference room C has completed.

The network interface 808 enables communications between the videoconferencing endpoint 800 and other devices and can be wired, wireless or a combination. In one example, the network interface 808 is connected or coupled to the Internet 830 to communicate with remote endpoints 840 in a videoconference. In one or more examples, the I/O interface 810 provides data transmission with local devices such as a keyboard, mouse, printer, projector, display, external loudspeakers, additional cameras, and microphone pods, etc.

In one example, the imager 816 and external camera 819 and the microphone array 814 and microphones 815A and 815B capture video and audio, respectively, in the videoconference environment and produce video and audio streams or signals transmitted through the bus 817 to the processing unit 802. In at least one example of this disclosure, the processing unit 802 processes the video and audio using algorithms in the modules stored in the flash memory 804. Processed audio and video streams can be sent to and received from remote devices coupled to network interface 808 and devices coupled to general interface 810. This is just one example of the configuration of a videoconferencing endpoint 800.

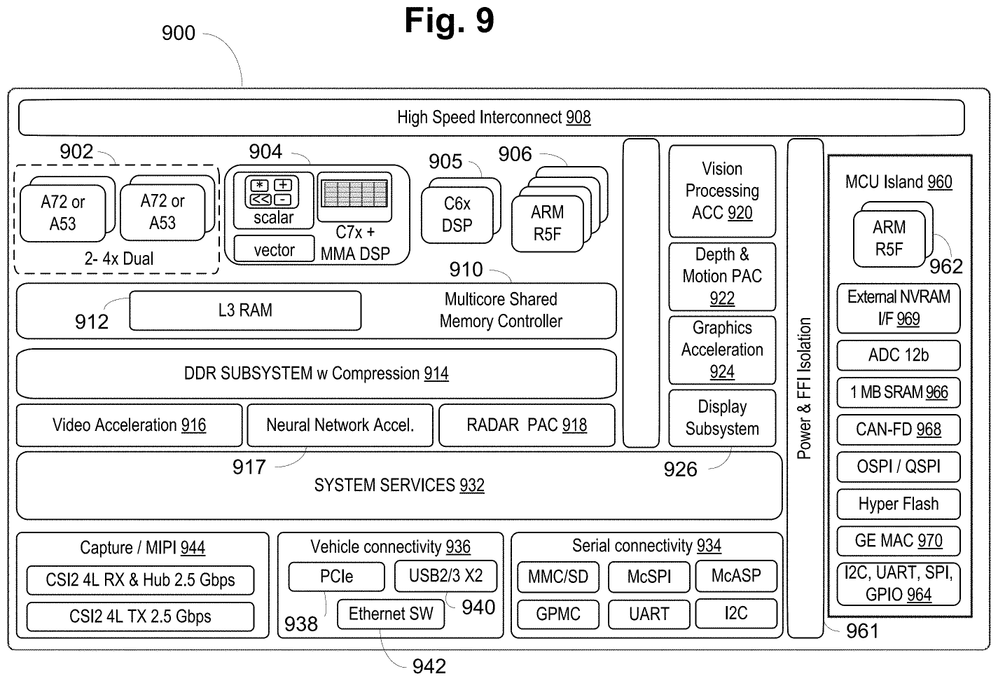

FIG. 9 is a block diagram of an exemplary system on a chip (SoC) 900 as can be used as the processing unit 802. A series of more powerful microprocessors 902, such as ARM® A72 or A53 cores, form the primary general-purpose processing block of the SoC 900, while a more powerful digital signal processor (DSP) 904 and multiple less powerful DSPs 905 provide specialized computing capabilities. A simpler processor 906, such as ARM R5F cores, provides general control capability in the SoC 900. The more powerful microprocessors 902, more powerful DSP 904, less powerful DSPs 905 and simpler processor 906 each include various data and instruction caches, such as L1I, L1D, and L2D, to improve speed of operations. A high-speed interconnect 908 connects the microprocessors 902, more powerful DSP 904, simpler DSPs 905 and processors 906 to various other components in the SoC 900. For example, a shared memory controller 910, which includes onboard memory or SRAM 912, is connected to the high-speed interconnect 908 to act as the onboard SRAM for the SoC 900. A DDR (double data rate) memory controller system 914 is connected to the high-speed interconnect 908 and acts as an external interface to external DRAM memory. The RAM 805 or 805 are formed by the SRAM 912 and external DRAM memory. A video acceleration module 916 and a radar processing accelerator (PAC) module 918 are similarly connected to the high-speed interconnect 908. A neural network acceleration module 917 is provided for hardware acceleration of neural network operations. A vision processing accelerator (VPACC) module 920 is connected to the high-speed interconnect 908, as is a depth and motion PAC (DMPAC) module 922.

A graphics acceleration module 924 is connected to the high-speed interconnect 908. A display subsystem 926 is connected to the high-speed interconnect 908 to allow operation with and connection to various video monitors. A system services block 932, which includes items such as DMA controllers, memory management units, general-purpose I/O's, mailboxes, and the like, is provided for normal SoC 900 operation. A serial connectivity module 934 is connected to the high-speed interconnect 908 and includes modules as normal in an SoC. A vehicle connectivity module 936 provides interconnects for external communication interfaces, such as PCIe block 938, USB block 940 and an Ethernet switch 942. A capture/MIPI module 944 includes a four-lane CSI-2 compliant transmit block 946 and a four-lane CSI-2 receive module and hub.

An MCU island 960 is provided as a secondary subsystem and handles operation of the integrated SoC 900 when the other components are powered down to save energy. An MCU ARM processor 962, such as one or more ARM R5F cores, operates as a master and is coupled to the high-speed interconnect 908 through an isolation interface 961. An MCU general purpose I/O (GPIO) block 964 operates as a slave. MCU RAM 966 is provided to act as local memory for the MCU ARM processor 962. A CAN bus block 968, an additional external communication interface, is connected to allow operation with a conventional CAN bus environment in a vehicle. An Ethernet MAC (media access control) block 970 is provided for further connectivity. External memory, generally non-volatile memory (NVM)such as flash memory 804, is connected to the MCU ARM processor 962 via an external memory interface 969 to store instructions loaded into the various other memories for execution by the various appropriate processors. The MCU ARM processor 962 operates as a safety processor, monitoring operations of the SoC 900 to ensure proper operation of the SoC 900.

It is understood that this is one example of an SoC provided for explanation and many other SoC examples are possible, with varying numbers of processors, DSPs, accelerators and the like.

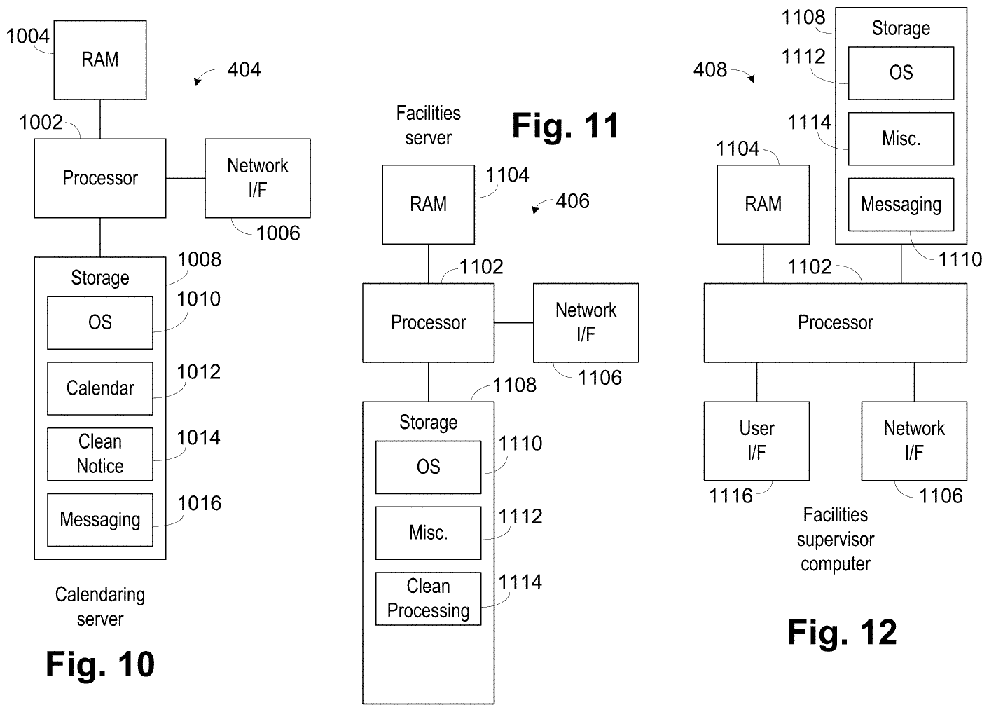

FIG. 10 is a block diagram of the calendaring server 404. The calendaring server 404 includes a processor 1002, RAM 1004, a network interface 1006 and non-volatile storage 1008. The non-volatile storage 1008 includes an operating system 1010, the basic calendaring software 1012, clean notice software 1014, which performs the operations of FIG. 5, and messaging software 1016 to send notices to the facilities server 406. This is a high-level block diagram for illustration purposes and many alternative configurations are possible.

FIG. 11 is a block diagram of the facilities server 406. The facilities server 406 includes a processor 1102, RAM 1104, a network interface 1106 and non-volatile storage 1108. The non-volatile storage 1108 includes an operating system 1110, miscellaneous software 1112, clean processing software 1114, which performs the operations of FIG. 7, and messaging software 1116, which sends messages to the facilities supervisor computer 408. This is a high-level block diagram for illustration purposes and many alternative configurations are possible. The facilities server 406 can be part of another computing device, such as a videoconferencing endpoint Boo or the facilities supervisor computer 408. The facilities server 406 can be a physical server or operate as a virtual server in a cloud computing environment.

FIG. 12 is a block diagram of the facilities supervisor computer 408, often a conventional desktop or laptop computer used for normal work functions by the facilities supervisor. The facilities supervisor computer 408 includes a processor 1202, RAM 1204, a network interface 1206, non-volatile storage 1208 and a user interface 1216, such as a monitor, keyboard and mouse. The non-volatile storage 1208 includes an operating system 1210, miscellaneous software 1212 and messaging software 1214 to receive notifications from the facilities server 406 and display those notifications to the facilities supervisor, so that the facilities supervisor can arrange for a conference room to be cleaned. This is a high-level block diagram for illustration purposes and many alternative configurations are possible.

While the above discussion has focused on conference rooms and offices, many other room types and building types can also be used. In an office environment, auditoriums, lounge spaces and other common spaces which have scheduled uses are suitable for such monitoring.

While providing a notice of a messy conference room to a facilities supervisor has been used as the example, other actions can also be automatically triggered, such as contacting additional parties involved with the conference room use, such as the meeting organizer or the organizer's assistant. The messy state can also be logged, including being logged into the records all of parties attending the meeting, so that repeat offenders can be detected and provided further instruction.

It is understood that devices other than videoconferencing endpoints can be used in a conference room. Simple IP-connected cameras can be used to provide the reference and sample or obtained images. The informal meeting processing could be performed on the facilities server, the facilities server polling the conference room cameras for images to use to detect individuals in the conference room and then proceeding as described above for the operation of the videoconferencing endpoint, providing an internal notification from the image processing process to the clean or messy processes.

By detecting the neatness of a conference room or other common area after a scheduled meeting or an informal meeting, the conference room be provided in a neat condition for the next user. The detection is performed by comparing a reference image of the properly arranged conference room with an image of the conference room obtained after the scheduled meeting or informal meeting using traditional vision processing. Alternatively, the detection is performed using a neural network trained to determine the neatness of the conference room. A neatness score is developed and compared to a selectable threshold. If the conference room is messier than the selectable threshold, a notice is provided to the facilities supervisor to arrange for cleaning and straightening up of the conference room. The use of the automated neatness determination allows many different conference rooms and other common area to be maintained without requiring additional cleaning staff.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes receiving a completion notification of completion of use of a common area of a multiplicity of common areas. The method also includes obtaining an image of the arrangement of items in the common area based on the receipt of the completion notification. The method also includes developing a neatness score of the arrangement of items in the common area as shown in obtained image. The method also includes determining if the neatness score indicates a neatness level messier than the neatness level of a selectable threshold. The method also includes providing a messy notification to a user when the neatness score indicates a neatness level messier than the neatness level of the selectable threshold. Other examples of this aspect include corresponding computer systems, apparatus, and computer programs recorded on one or more computer storage devices, each configured to perform the actions of the methods.

Implementations may include one or more of the following features. The completion notification is received from a calendaring server maintaining a schedule of the multiplicity of common areas. The completion notification is received from a videoconferencing endpoint located in the common area, the videoconferencing endpoint performing face or body detection to determine use of the common area. Obtaining an image of the arrangement of items in the common area is further based on periodically determining the need to evaluate the neatness of the common area. Developing a neatness score can include obtaining a reference image of the arrangement of items in the common area; and comparing the reference image and the obtained image and determining a distance metric between the reference image and the obtained image, the distance metric representing the neatness score. Developing a neatness score can include training a neural network to determine neatness level of the common area, the neural network having an output of a neatness score; and processing the obtained image by the neural network and obtaining the output neatness score. The messy notification includes the obtained image of the common area. Implementations of the described techniques may include hardware, a method or process, or computer software on a computer-accessible medium.

The various examples described are provided by way of illustration and should not be construed to limit the scope of the disclosure. Various modifications and changes can be made to the principles and examples described herein without departing from the scope of the disclosure and without departing from the claims which follow.

1. A method for maintaining neat facilities, the method comprising:
receiving a completion notification of completion of use of a common area of a multiplicity of common areas;
obtaining an image of the arrangement of items in the common area based on the receipt of the completion notification;
developing a neatness score of the arrangement of items in the common area as shown in obtained image;
determining if the neatness score indicates a neatness level messier than the neatness level of a selectable threshold; and
providing a messy notification when the neatness score indicates a neatness level messier than the neatness level of the selectable threshold.

2. The method of claim 1, wherein the completion notification is received from a calendaring server maintaining a schedule of the multiplicity of common areas.

3. The method of claim 1, wherein the completion notification is received from a videoconferencing endpoint located in the common area, the videoconferencing endpoint performing face or body detection to determine use of the common area.

4. The method of claim 1, further comprising:
periodically determining the need to evaluate the neatness of the common area, and
wherein obtaining an image of the arrangement of items in the common area is further based on receipt of the periodic notification.

5. The method of claim 1, wherein developing a neatness score includes:
obtaining a reference image of the arrangement of items in the common area; and
comparing the reference image and the obtained image and determining a distance metric between the reference image and the obtained image, the distance metric representing the neatness score.

6. The method of claim 1, wherein developing a neatness score includes:
training a neural network to determine neatness level of the common area, the neural network having an output of a neatness score; and
processing the obtained image by the neural network and obtaining the output neatness score.

7. The method of claim 1, wherein the messy notification includes the obtained image of the common area.

8. A non-transitory processor readable memory containing instructions that when executed cause a processor or processors to perform the following method of maintaining neat facilities, the method comprising:
receiving a completion notification of completion of use of a common area of a multiplicity of common areas;
obtaining an image of the arrangement of items in the common area based on the receipt of the completion notification;
developing a neatness score of the arrangement of items in the common area as shown in obtained image;
determining if the neatness score indicates a neatness level messier than the neatness level of a selectable threshold; and
providing a messy notification when the neatness score indicates a neatness level messier than the neatness level of the selectable threshold.

9. The non-transitory processor readable memory of claim 8, wherein the completion notification is received from a calendaring server maintaining a schedule of the multiplicity of common areas.

10. The non-transitory processor readable memory of claim ₉, wherein the completion notification is received from a videoconferencing endpoint located in the common area, the videoconferencing endpoint performing face or body detection to determine use of the common area.

11. The non-transitory processor readable memory of claim 8, the method further comprising:
periodically determining the need to evaluate the neatness of the common area, and
wherein obtaining an image of the arrangement of items in the common area is further based on receipt of the periodic notification.

12. The non-transitory processor readable memory of claim 8, wherein developing a neatness score includes:
obtaining a reference image of the arrangement of items in the common area; and
comparing the reference image and the obtained image and determining a distance metric between the reference image and the obtained image, the distance metric representing the neatness score.

13. The non-transitory processor readable memory of claim 12, wherein developing a neatness score includes:
training a neural network to determine neatness level of the common area, the neural network having an output of a neatness score; and
processing the obtained image by the neural network and obtaining the output neatness score.

14. The non-transitory processor readable memory of claim 8, wherein the messy notification includes the obtained image of the common area.

15. A system for maintaining a neat facility, the system comprising:
a network interface for communicating over a local area network;
RAM;
a processor coupled to the network interface and the RAM for executing instructions; and
memory coupled to the processor for storing instructions executed by the processor, the memory storing instructions executed by the processor to perform the operations of:
receiving a completion notification from the local area network of completion of use of a common area of a multiplicity of common areas;
obtaining an image from the local area network of the arrangement of items in the common area based on the receipt of the completion notification;
developing a neatness score of the arrangement of items in the common area as shown in obtained image;
determining if the neatness score indicates a neatness level messier than the neatness level of a selectable threshold; and
providing a messy notification over the local area network when the neatness score indicates a neatness level messier than the neatness level of the selectable threshold.

16. The system of claim 15, wherein the completion notification is received from a calendaring server maintaining a schedule of the multiplicity of common areas.

17. The system of claim 16, wherein the completion notification is received from a videoconferencing endpoint located in the common area, the videoconferencing endpoint performing face or body detection to determine use of the common area.

18. The system of claim 15, wherein developing a neatness score includes:
obtaining a reference image of the arrangement of items in the common area; and
comparing the reference image and the obtained image and determining a distance metric between the reference image and the obtained image, the distance metric representing the neatness score.

19. The system of claim 15, wherein developing a neatness score includes:
training a neural network to determine neatness level of the common area, the neural network having an output of a neatness score; and
processing the obtained image by the neural network and obtaining the output neatness score.

20. The system of claim 19, wherein the messy notification includes the obtained image of the common area.
